(19) United States
(12) Patent Application Publication
(10) Pub. No.: US 2024/0068454 A1
(43) Pub. Date: Feb. 29, 2024

(54) ROTATIONAL IONIC ENGINE WITH TOROIDAL COUNTER ELECTRODE

(71) Applicant: The Research Foundation for the State University of New York, Albany, NY (US)

(72) Inventors: Adrian Ieta, Oswego, NY (US); Marius Chirita-Mihaila, Timisoara (RO)

(21) Appl. No.: 18/229,516

(22) Filed: Aug. 2, 2023

Related U.S. Application Data
(63) Continuation-in-part of application No. 17/057,465, filed on Nov. 20, 2020, now Pat. No. 11,863,040.
(60) Provisional application No. 63/394,467, filed on Aug. 2, 2022.
(60) Provisional application No. 62/674,022, filed on May 21, 2018.

(51) Int. Cl. F03H 1/00; B64D 27/24

(52) U.S. Cl. CPC F03H 1/0037; B64D 27/24

(57) ABSTRACT

An ionic wind propulsion system with a toroidal counter electrode that allows in-atmosphere propulsion in negative polarity. There are pin emitters extended on the trailing edge of a propeller placed above the toroidal counter-electrode that provides axial thrust with a corona discharge upon an electric current being applied. Axial thrust occurs due to the linear acceleration of ions between electrodes and the induced rotary motion of the propeller which captures the energy and momentum of ions accelerated in the propeller's rotational plane. An array of propellers and toroidal counter electrodes can be used to power aircraft, such as drones.

### CROSS-REFERENCE TO RELATED APPLICATION

This application claims the benefit of U.S. Provisional Application No. 63/394,467, filed Aug. 2, 2022, and is a continuation-in-part of U.S. patent application Ser. No. 17/057,465, filed Nov. 20, 2020, which is the national phase entry of PCT/US19/33413, filed May 21, 2019, which claims the benefit of U.S. Provisional Application No. 62/674,022, filed May 21, 2018, the entirety of all of which is hereby incorporated herein by this reference.

### BACKGROUND OF THE INVENTION

### 1. Field of the Invention

The present invention generally relates to propulsion systems. More particularly, the present invention relates to a toroidal counter electrode housing for harnessing an ionic wind for propulsion.

### 2. Description of the Related Art

There is an increasing interest in using ionic wind for propulsion of aircraft. The first demonstration of an ionic craft able to lift off and carry its own power supply was performed using negative polarity. More recently, a plane/glider was able to maintain flight using ionic wind generated in a positive polarity; a wirelessly powered flying ionic craft was also reported. An ionic wind generated in atmospheric air can be produced by applying high voltage between two dissimilar electrodes and above the corona discharge threshold (but below the air breakdown value). Ions of the polarity applied to the emitter electrode are generated nearby sharp metal edges and within a very thin ionization layer in a fairly complex process.

Upon acceleration of the ions in the electric field between the electrodes, collisions with the adjacent neutral molecules happen and the ions eventually create an overall air movement from the emitter electrode to the counter electrode where they become neutralized. The electric field mediates the conversion of momentum and energy to the air movement and the electrode system. If the emitter can spin about an axis, ionic rotational motion can also be induced. A recent rotational device with enhanced ionic wind emission was recently reported. The device was designed with a propeller carrying pin emitter electrodes, concentrical cylindrical counter electrode and worked in negative polarity. Negative polarity was experimentally demonstrated to allow for an overall much larger thrust in air than positive polarity.

Negative corona discharges develop gradually into a breakdown while positive corona discharges develop abruptly into a breakdown. The breakdown voltage of an electrode configuration in negative polarity is larger than in positive polarity, sometimes almost double than for positive voltage breakdown value using the same electrode configuration. Therefore, the ions in negative polarity can be accelerated in a larger electric field intensity within the voltage range not available to the positive polarity.

A major problem with rotational ionic engines is that the amount of thrust produced has been insufficient to power even small aircraft. It is difficult for heavier-than-air vehicles to achieve take off and fly in large part due to the weight of the required power electronics to create the ionic wind. Therefore, improved ionic flow-based rotary systems and methods are needed to produce usable rotational forces for thrust.

### BRIEF SUMMARY OF THE INVENTION

Briefly described, the present invention creates an improved ionic flow engine with a novel electrode configuration with a toroidal body. A propeller is coaxially placed above a toroidal counter electrode. Ionic propellers are known to be able to spin and generate conventional axial thrust enough to lift off the high voltage shaft and fly freely for a while without carrying a power supply. But with sufficient axial thrust generated with rotary ionic engines, rotary ionic drones are feasible. Such drones would have low sound and thermal signature, simplicity of engine design, low cost, and no carbon emissions.

In one embodiment, rotational ionic engines can be constructed with coaxial contra-rotating propellers and zero angular momentum. Their advantages over traditional atmospheric ion thruster configurations include kinetic energy storage by the propellers with additional flight stability added, smooth running even in non-uniform electric fields, and a relatively robust design when compared to the usage of extra thin and long wires for classic atmospheric thruster configurations.

In one configuration, double coaxial propellers can be used to produce much larger thrust and thrust density if larger currents are available. However, due to the fixed distance between the pin emitters and the counter electrode, a limitation is imposed by the maximum voltage that can be applied before air breakdown occurs, i.e. arcing can occur. Thrust density has been a recurrent issue with ionic crafts as they require a very large area for more meaningful thrust to be generated.

Accordingly, the present invention addresses such limitations by changing the electrode configuration. The propeller was coaxially placed above a toroidal counter electrode which intends to remove essential limitations of the extant rotational ionic engine configurations. This allows a larger surface area of the counter electrode to generate a greater ionic wind flow from and through the propeller to generate thrust.

In one embodiment, the rotational ionic engine includes at least one rotary device comprising a hub portion, an axis of rotation, and at least one blade extending radially from the hub portion to an outer tip thereof, the at least one blade comprising a front leading edge, a back trailing edge and top and bottom surfaces that extends between the front and back edge. There is at least one electrically conductive rotary electrode emitter coupled to the back edge of the at least one blade and proximate to the outer tip of the at least one blade.

The at least one electrically conductive counter electrode is positioned proximately to the at least one rotary device in a spaced relationship therefrom to optimal the potential ionic wind from an increased electrical potential between the emitter and the toroidal body, and the body has an internal passage therethrough with an intake and exit for a fluid flow. The internal passage includes at least a partial internal taper from the intake to the exit.

There is also an electrical system that includes a voltage source including a first terminal electrically coupled to the at least one rotary electrode emitter and a second terminal electrically coupled to the at least one counter electrode, the voltage source comprising an electric potential difference between the first terminal and second terminal that selectively generates corona discharges from the at least one rotary electrode emitter to form a flow of ionic wind emanating therefrom that rotates the at least one rotary device about the axis of rotation in a first direction such that the ionic wind flows through the intake of the internal passage of the counter electrode and out from the exit thereof, thereby creating a thrust.

In another embodiment, the invention includes a counter electrode of a rotational ionic engine the electrode has a toroidal body with an internal passage therethrough, having an intake and exit for a fluid flow, and the internal passage including at least a partial internal taper from the intake to the exit. The body has an electrical connection to an electrical system, the electrical connection selectively providing a voltage to the body, wherein the body configured to, upon an electric voltage applied to the electrical connection, receive a flow of ionic wing through the intake of the internal passage of the body and out from the exit thereof, thereby creating a thrust.

The present invention is therefore advantageous as it is a rotational ionic engine that creates sufficient atmospheric thrust to power flight, or otherwise move a vehicle through a fluid. Further, the present invention has industrial applicability in that it can provide drones and other heavier-than-air vehicles that propel through the atmosphere and maintain flight with ionic thrust alone. It is to such an improved rotational ionic engine that the present invention is primarily directed.

### BRIEF DESCRIPTION OF THE DRAWINGS

FIG. 1A is a perspective diagram with a top view of the mechanism of thrust in an ionic propeller-cylindrical counter electrode rotational ionic engine (RIE).

FIG. 1B is a side perspective view of the RIE with a known cylindrical counter electrode and ionically induced air flow.

FIG. 1C is a sequence of 50 ms images of the ionic wind initiation in a RIE with an extant cylindrical collector.

FIG. 2A is a 3-dimensional diagram of electric field projections at an emitter electrode of a propeller.

FIG. 2B is a 3-dimensional diagram of a force acting on the ion projections at the emitter electrodes.

FIG. 2C is a top view of the one embodiment of the present RIE system, with the propeller coaxial to the toroidal counter electrode.

FIG. 2D is a side view of the embodiment of the RIE system in FIG. 2C.

FIG. 2E is a cross-section of the toroidal counter electrode along Axis Y in FIG. 2B.

FIG. 3A is a top view of one embodiment of the propeller illustrating the pin (electrode emitter) placements.

FIG. 3B is a perspective view of one embodiment of the toroid counter electrode body.

FIG. 3C is a perspective view of the toroid counter electrode body in FIG. 3B covered in conductive material to form a grounded counter-electrode, with the propeller of FIG. 3A in position over the internal passage of the body.

FIG. 3D is a cross section details of one embodiment of the toroidal counter electrode design, with dimensions given in mm.

FIG. 4A is a top view of a toroidal RIE mounted on a measuring device.

FIG. 4B is a view of one embodiment of a setup used for measuring the airflow speed and estimation of the volume flow rate, an anemometer with a rotating vane and a plastic adaptor for focusing flow

FIG. 4C is a perspective view of one embodiment of the RIE system mounted on the thrust measuring seesaw device.

FIG. 4D is perspective view of 4-RIE array mounted on the seesaw measuring device of FIG. 4C.

FIG. 5A is a graph illustrating the variation of the ionic axial thrust with rotational speed in RIEs with toroidal and cylindrical counter electrodes.

FIG. 5B is a graph illustrating the variation of the ionic axial thrust with current in RIEs with toroidal and cylindrical counter electrodes, with additional comparison made for systems with a blocked ionic propeller and for systems using the shaft/pin as emitter.

FIG. 5C is a graph illustrating the variation of the ionic axial thrust with a change in voltage,

FIG. 5D is a graph illustrating a current-voltage characteristic of the studied configurations in FIGS. 5B-5C.

FIG. 6 is a graph illustrating the sample variation of the axial thrust with the height above the propeller at ˜98 kV for a RIE with a toroidal collector.

FIG. 7A is a graph illustrating the maximum RIE axial thrust dependance on the propeller axial height above the toroidal counter electrode at various voltages.

FIG. 7B is a graph illustrating the variation of the axial thrust per cm height for a 20 kV increase in the applied voltage and positioning of the propeller above toroid at the optimal height (maximum thrust for the applied voltage).

FIG. 8A is a top view of a two-RIE toroidal array mounted for ionic thrust measurement.

FIG. 8B is a top view of a three-RIE toroidal array mounted for ionic thrust measurement.

FIG. 8C is a top view of a four-RIE toroidal array mounted for ionic thrust measurement.

FIG. 8D is a perspective view of and extant four-blade X15A Guangdong Syma drone mounted for thrust measurement and comparison to the arrays of FIGS. 8A-8D.

FIG. 9 is a graph illustrating toroidal axial thrust dependence on the voltage and the number of parallel-connected units/toroidal RIEs used.

FIG. 10A is a graph illustrating experimentally observed direct proportionality of the thrust to power ratio (TIP) and the propeller kinetic energy to power ratio (KE/P).

FIG. 10B is a graph illustrating experimentally observed direct proportionality of the T/P ratio and the voltage to current (V/I) ratio.

### DETAILED DESCRIPTION

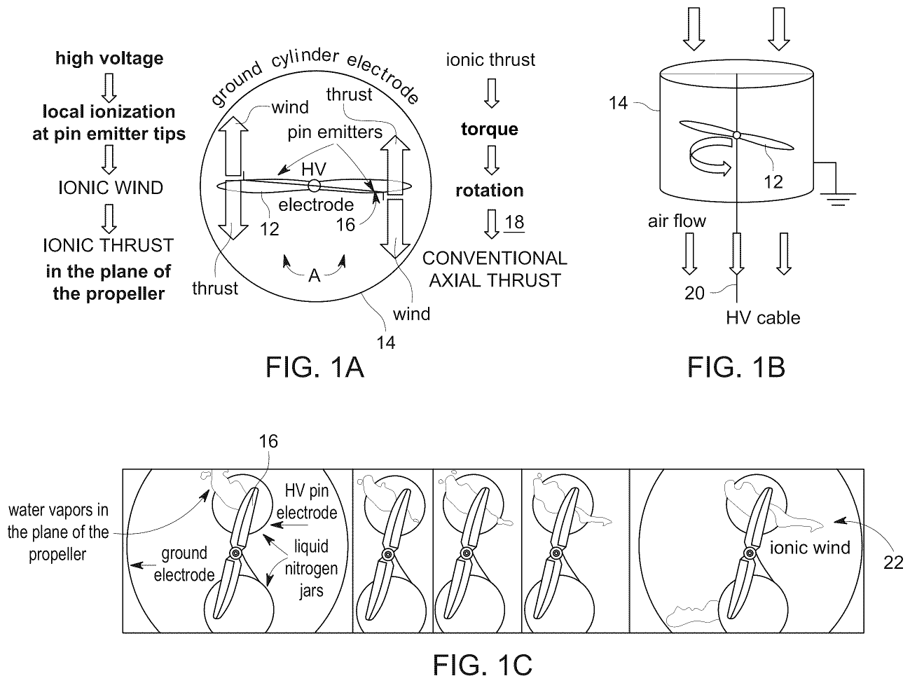

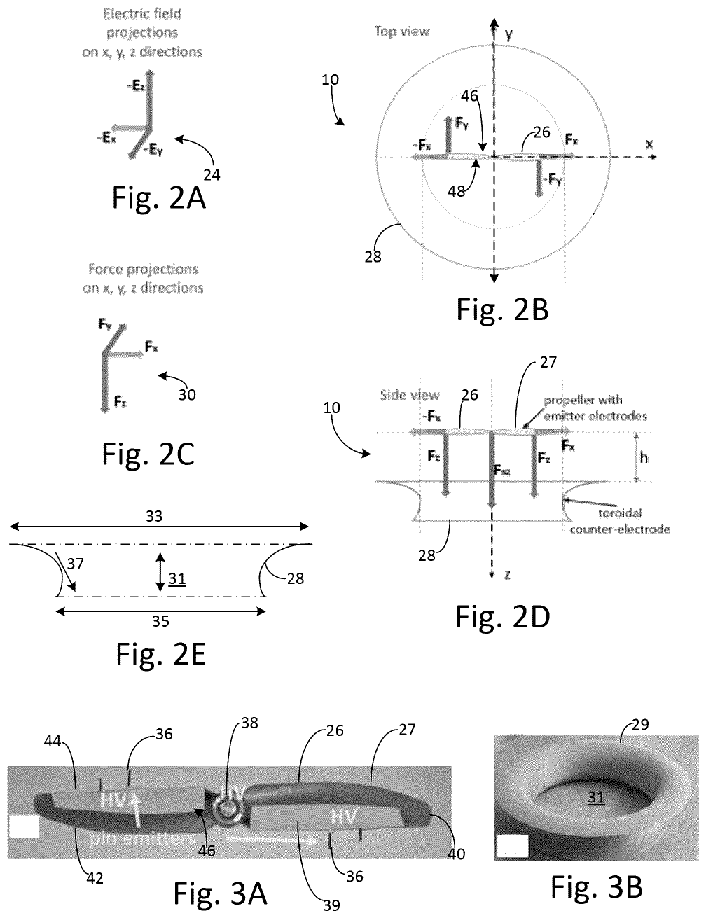

With reference to the figures in which like numerals represent like elements throughout the several views, the mechanism of thrust in the rotational ionic engine (RIE) system 10 (FIG. 2B) is related to the ion emission and motion along the field lines during the corona discharge process. Such corona discharges in air result in multiple charge carrier species and dynamic space charge distributions which do not render themselves easy to precise modeling. This is due to the complexity of the processes involved in electrohydrodynamic flows of gas discharges. In the case of negative polarity applied to the pin emitters, the thrust results due to the negative ions produced in the close vicinity of the sharp edges of the pin electrodes. Although some positive ions are generated as well, they are quickly neutralized at the pin emitter tips where they are produced. The mechanism of thrust in a RIE with a traditional cylindrical counter electrode is shown in FIGS. 1A-1C.

FIG. 1A is a perspective diagram with a top view of the mechanism of thrust in an ionic propeller-cylindrical counter electrode rotational ionic engine (RIE). To obtain the pictures of FIG. 1C, a laser sheet was projected within the plane A of the propeller 12 rotation to visualize condensed water vapors induced by a liquid nitrogen container/jar placed below the ionic propeller. A Photron SA-X2 high-speed camera was used at 1000 fps. The high voltage applied between the electrodes generates a very intense electric field at the tip of the pin emitters 16, which leads to local ionization and production of mainly ions of the same kind to the polarity applied at the emitters 16. Within the thin ionization region, the coulombic repulsion between the negative pin tips and the ions is very large and leads to the propeller 12 rotation. On the other hand, the moving ions in electric field convey momentum to the neutral air molecules generating ionic wind. Axial conventional thrust 18 is produced due to the coulombic repulsion of the propeller 12 blades and ions within the close region of ionization area.

FIG. 1B is a side perspective view of the RIE with a known cylindrical counter electrode 14 and ionically induced air flow. The side view of the extant RIE counter electrode configuration further leads to torque and axial airflow and conventional axial thrust 18 as the propeller 12 spins. High voltage cable 20 is also illustrated.

FIG. 1C is a sequence of 50 ms images of the ionic wind initiation in a RIE with an extant cylindrical collector. From left to right: 50 ms image sequence of the ionic wind initiation in a RIE with cylindrical collector 14. The very inception of the ionic wind in the RIE system was recorded on a high-speed camera (Photron SA-X2) using a special setup for visualization of the electrohydrodynamic flows (FIG. 1C). The ionic wind 22 starts at the very tip of the pin 16, apparently tangent to the pin 16, and further curves towards the cylindrical collector electrode 14.

The thrust in an ionic system can be calculated by accounting for all the electrical forces acting on the ions within a specific volume:

T=−∫ρ(∇V)dv

where V is the voltage potential and ρ is the charge density within the volume dv. The thrust-to-power ratio is a common measure for efficiency of propulsion systems. For RIEs with cylindrical counter electrode, the ratio was shown to be approximately proportional to the ratio of propeller rotational kinetic energy (KE) to power (P) at voltages much larger than the corona onset

$${η}_{T} = \frac{T}{P} = {Λ}_{E} \frac{KE}{P}$$

where Λ_{E} is a constant. The thrust to power ratio was also shown to be proportional to the voltage to current ratio

$${η}_{T} = \frac{T}{P} = {Λ}_{R} \text{?}$$

$$\text{?} \text{indicates text missing or illegible when filed}$$

where Λ_{R} is a constant.

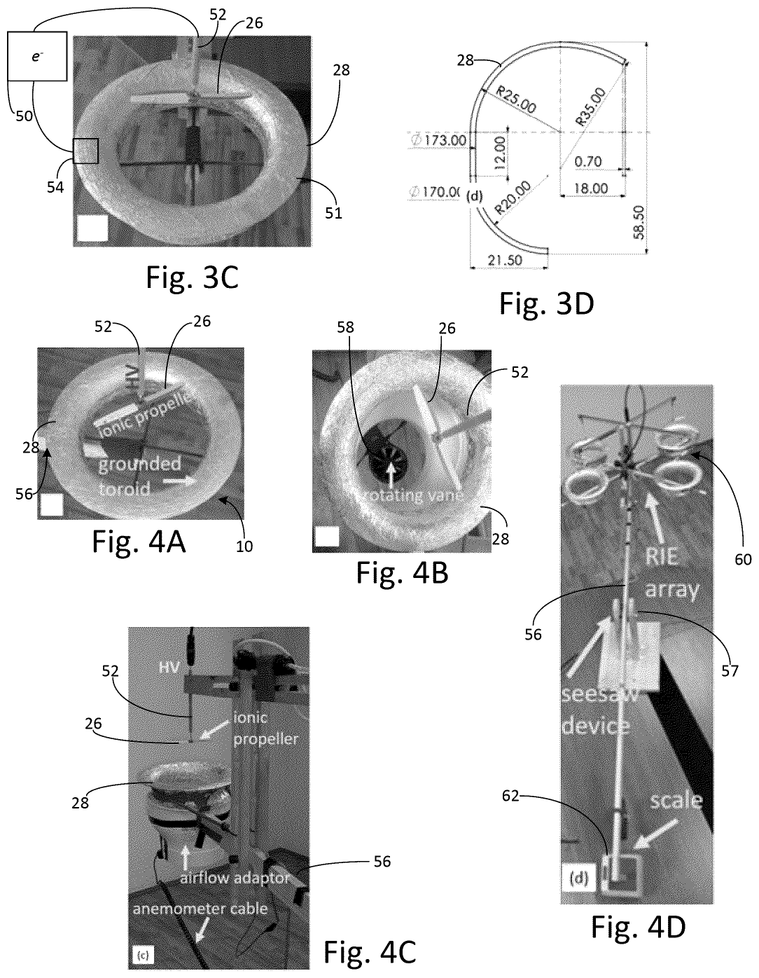

Using a toroidal ground instead of a cylindrical one preserves the symmetry of the electric field during the rotational motion of the propeller equipped with pin emitters. Experimental work presented here shows that RIEs with toroidal ground counter electrodes 28 (FIGS. 2A-2C and 3A-3D) appear to have significant advantages in helping the system achieve more axial thrust than RIEs with cylindrical counter electrodes 14. The ionic thrust Z was demonstrated in unidimensional models (also experimentally in certain electrode configurations) to be directly proportional to the corona current. However, as the ionic current has a three-dimensional distribution and is not necessarily aligned in the direction of useful thrust, such relation can only be a rough approximation in arbitrary configurations.

FIG. 2A is a 3-dimensional diagram 24 of electric field projections at an emitter electrode of a propeller. Axial thrust generation in a RIE 10 with toroidal counter electrode 28. The electric field projections Eₓ, E_{y}, E_{z} at the emitter electrodes 36 (FIG. 3A) shows the schematics of a RIE 10 with pin emitters on a propeller 26 placed above a toroidal ground counter electrode 28.

FIG. 2B is a 3-dimensional diagram 30 of a force acting on the ion projections at the emitter electrodes 36 (FIG. 3A). Forces Fₓ, F_{y}, F_{z} are acting on the ion projections at the emitter electrodes 36. FIG. 2C is a top view of the one embodiment of the present RIE system 10, with the propeller 26 coaxial to the toroidal counter electrode 28.

FIG. 2D is a side view of the embodiment of the RIE system 10 in FIG. 2B. Here, a rotational ionic engine 10 is embodied with at least one rotary device (propeller 26) comprising a hub portion 38 (FIG. 3A), an axis of rotation Z (FIG. 2D), and at least one blade 27 extending radially from the hub portion 38 to an outer tip 40 thereof. The blade 26 includes a front leading edge 42, a back trailing edge 44, and top surface 46 and bottom surface 48 that extend between the front edge 42 and back edge 44. There is at least one electrically conductive rotary electrode emitter (pin 36) coupled to the back edge 44 of the blade 27 and proximate to the outer tip 40 of the at least one blade 27. FIG. 2E is a cross-section of the toroidal counter electrode along Axis Y in FIG. 2B.

There is at least one electrically conductive counter electrode (toroid body 28) positioned proximately to the at least one rotary device (propeller 26) in a spaced relationship therefrom. With reference to FIGS. 2E and 3B, the counter electrode 28 having a toroidal body 29 (FIG. 3B) having an internal passage 31 (FIG. 2E) therethrough, the internal passage 31 having an intake 33 and exit 35 for a fluid flow, the internal passage 31 including at least a partial internal taper 37 from the intake 33 to the exit 35. The body 29 can be selectively electrically conductive, or have other materials, such as aluminum foil 51 (FIG. 3C) or other conductive or semiconductive metal or materials.

With further reference to FIG. 3C, the RIE 10 includes an electrical system with a voltage source 50 including a first terminal 52 electrically coupled to the at least one rotary electrode emitter (propeller 26) and a second terminal 54 electrically coupled to the at least one toroid counter electrode 28, the voltage source 50 comprising an electric potential difference between the first terminal 52 and second terminal 54 that selectively generates corona discharges from the at least one rotary electrode emitter 36 to form a flow of ionic wind emanating therefrom that rotates the at least one rotary device (propeller 26) about the axis of rotation (Axis Z in FIG. 2D) in a first direction such that the ionic wind flows through the intake 33 of the internal passage 31 of the counter electrode 28 and out from the exit 35 thereof, thereby creating a thrust.

The voltage source 50 of the electrical system can be a battery, a generator, a fuel cell, a solar cell, an electrical grid input line, a supercapacitor, or a combination thereof. Further, the electrical system can apply a negative polarity having relatively high voltage above corona onset to the rotary electrode emitter 52 of the blade 27. Alternately, the electrical system can apply a positive polarity having a relatively high voltage above corona onset to the rotary electrode emitter 52 of the blade 27. Furthermore, the electrical system can apply either a direct current or alternating current to the rotary electrode emitter 36 of the blade 27. The voltage can be at a high-voltage sufficient to maintain a corona onset for propulsion.

In an embodiment, the hub portion 38 can be an electrically conductive portion, such as shaft 52 that is electrically coupled to the rotary electrode emitter 36. The conductive portion can extend through the counter electrode as shown with the conductive cable 20 in FIG. 1B.

In one embodiment, the invention includes a counter electrode 28 of a rotational ionic engine with a toroidal body 29 having an internal passage 31 therethrough, the internal passage 31 having an intake 33 and exit 35 for a fluid flow, the internal passage 31 including at least a partial internal taper 37 from the intake 33 to the exit 35. The toroid body 29 includes an electrical connection 54 to an electrical system, the electrical connection 54 selectively providing a voltage to the body 29 and the toroidal body 29 is configured to, upon an electric voltage (voltage source 50) applied to the electrical connection 54, receive a flow of ionic wind through the intake 33 of the internal passage 31 of the body 29 and out from the exit 35 thereof, thereby creating a thrust.

With further specific reference to FIGS. 3A-3D, FIG. 3A is a top view of one embodiment of the propeller 26 illustrating the pin 36 (electrode emitter) placements. The ionic propeller 26 design with actual pin 36 positioning (12.6 cm propeller diameter). Here, the propeller 26 is equipped with a ball bearing unit (hub 38) on which high voltage (HV) is applied and distributed via a copper tape 25 to the pin emitters 36. The blade 27 can have an airfoil shape, and radially extends from the hub 38.

FIG. 3B is a perspective view of one embodiment of the toroid counter electrode body 29, here created as a non-conductive 3-D printed toroid. FIG. 3C is a perspective view of the toroid counter electrode body 29 in FIG. 3B covered in conductive material (here aluminum foil 51) to form a grounded counter-electrode, with the propeller of FIG. 3A in an axial position over the internal passage 31 of the body 29.

FIG. 3D is a cross-section of the embodiment of the body 29 in FIG. 3B, with dimensions given in mm. This embodiment optimizes the ration of the voltage used to create an ionic flow versus the thrust created.

At the very core of the ionic thrust is the conservation of momentum of the electrode-air-charge carriers system which is mediated by the electric field. As the field lines are generated in space, there are three components of the electric field along the Ox, Oy, Oz, axes in which ions can and do move. Therefore, the associated ionic thrust has components along those axes. With a 3-D signature, the overall ionic thrust emerges as the superposition of the three components along the axes. In the case of the ionic propeller-toroid system (FIGS. 2A-2D), the axially generated thrust combines the mechanism of thrust for ionic propeller-cylinder system (FIGS. 1A-1B) to the classic linear momentum conservation in systems like pin-to-wire, wire-to-cylinder, or wire-to-airfoil systems.

The electric field generated above the toroid counter electrode 28 can be viewed as superposition of the field produced by rings of charges making up the toroid. An intense field is then generated at the tip of the emitter 36 electrodes. Ions are emitted in the very proximity of the pin tips and are subject to the electric field produced by the electrodes. As pin 36 emitters are extending on the trailing edge 44 of the blades 27, emitted ions will have an induced motion along the electric field projections: Ex—along the blade 27, Ey—perpendicular to the blade and in the propeller rotational plane, and Ez—parallel to the propeller axis of rotation, as shown in FIG. 2A. The corresponding electrical forces, Fx, Fy, and Fz, generate thrust and eventually rotational motion of the propellers due to the conservation of linear and angular momentum, as shown in FIG. 2C.

Fz leads to linear acceleration of ions between electrodes and to the generation of upwards axial thrust. Fy leads to torque exerted on the blades 27, which spins the propeller 26 and generates upwards axial conventional thrust. Fx does not lead to useful axial thrust as it is directed along the blade 27 and in opposite directions for the two blades. Due to the field lines orientation above the toroid counter electrode 28, the relative magnitude of Fx is estimated to be small by comparison to the other force projections. The overall axial thrust is therefore a superposition of the thrust associated to Fz and Fy (while it spins the propeller 26 and so generates conventional axial thrust).

The propeller 26 shaft can act as a pin emitter above the toroid counter electrode 28 and contribute to the axial thrust. The ions emitted at the central shaft Fsz (FIG. 2D) also lead to axial thrust superimposed on the axial thrust effects of the pin emitters 36 on the blades 27. Therefore, the overall axial thrust is a summation of the conventional thrust due to the rotation of the propeller 26 (induced by the ionic thrust in the plane of the propeller 26—Fy), and axial thrust (Fz+Fsz,) resulting from the field-induced motion of ions in the axial direction between electrodes (ions generated both by the pin emitters 36 on the blades 27 and also from the central shaft (such as shaft 20 in FIG. 1B).

A prior art RIE with cylindrical counter electrode (such as shown in FIGS. 1A-1B) has strong limitations in generating axial thrust partly due to the finite distance between emitter electrodes (e.g. 36) and cylinder walls (cylinder counter electrode 14). This leads to a maximum voltage that can be applied before gas breakdown occurs. This limitation is avoided by using a toroidal counter electrode 28 configuration, as the propeller 12 with emitters can always be elevated at an appropriate distance above the toroid body 29 such that a breakdown does not occur. Given that field lines direction and density change with the propeller 26 position above the toroid body 29, Fz, Fsz and Fy and their associated axial thrust also vary, so allowing for an optimal propeller height at which axial thrust is maximum for a given applied voltage (and above the corona onset).

Here, to demonstrate the efficacy of the invention RIE 10 with toroidal counter electrodes 28, several arrays were built with two-blade plastic propellers of 12.6 cm diameter and 1.87 g mass, The propellers 26 were equipped with pin emitters 36 as shown in FIG. 3A. Copper tape 39 was used to connect the propeller 26 ball bearing (hub 38) to the central shaft (52, FIG. 3C) and with two 0.4 cm regular pin emitters 36 per blade 27 extending on the blade trailing edge. The copper tape 39 connections are covered with electrical tape which limits the corona current losses. The propeller 26 was placed on a negative high voltage shaft 52 coaxially and above a toroidal ground counter electrode 28. A plastic body 29 of the toroidal counter electrode was 3-D printed (FIG. 3B). Various shapes were tested to optimize the shape of the toroid. The minimum diameter of the toroid body 29 was found optimal at 17 cm diameter, which is similar to the diameter used with the same type of propellers for RIEs with cylindrical counter electrodes (FIG. 1A-1B). Eventually, other specific dimensions were found to work well with the designed ionic propeller (FIG. 3D). Once printed, the toroid was covered in aluminum foil 51 to produce the ground collector electrode 28 (FIG. 3A).

A negative high voltage was applied to the RIE emitter electrodes from a Glassman power source PS/KT100R20-220 (±100 kV, 20MA). Rotational speed of the propeller was measured with a PCE-OM15 digital stroboscope tachometer with a response time of 0.3 s, 0.1 fpm resolution below 1000 fpm speed, and 1 fpm resolution above 1000 fpm. High speed imaging (FIG. 1C) was performed at 1000 fps with a Photron SA-X2 high-speed camera. Thrust measurements were performed with a two-meter long “seesaw” manufactured device which keeps the electronic scale far enough to cancel the electric effect from the high voltage testing site. The device allows for the separation between the intense electric field needed for the ionic wind and the thrust measuring devices—where no intense electric field should be present. The length of the seesaw arm was chosen experimentally, and with a large margin, so that the measuring electronic scale measurements are not influenced by the electric field generated in the high voltage region. The system was previously tested at the highest voltage available (100 kV) to fully verify that no data corruption is induced when using the scale with or without high voltage.

FIGS. 4A-4D illustrate the test of the REI 10. FIG. 4A is a top view of a toroidal RIE 10 mounted on a measuring device (seesaw 56). FIG. 4B is a view of one embodiment of the seesaw setup 56 used for measuring the airflow speed and estimation of the volume flow rate, with an anemometer 58 with a rotating vane and a plastic adaptor for focusing flow. FIG. 4C is a perspective view of one embodiment of the RIE 10 system mounted on the thrust measuring seesaw device 56. FIG. 4D is a perspective view of 4-RIE array 60 mounted on the seesaw measuring device 56 of FIG. 4C.

The specific physical details of the measuring setup 56 can be seen in FIG. 4D. The seesaw structure 56 balances around a central pivot 57. At one end the ionic system is mounted and powered with high voltage while at the opposite end a vertical arm extension rests on a Mayam electronic scale 62 able to measure up to 500 g-force with a 0.001 g-force accuracy. The scale 62 was zeroed every time the setup 56 was ready for thrust measurements and before the high voltage was applied. When RIE is mounted on the structure, the arm length on the high voltage area/RIE and the one on the electronic scale are equal hence facilitating direct readings of the thrust in g-force on the scale. The mounting of the RIE is more visible in FIG. 4C. The balancing arm was designed with an additional structure to facilitate easy mounting of the RIE 10 on the arm and also variable positioning of the propeller 26 above the toroid 28 collector. Additional supporting structures were designed for each of the 2-4 RIE arrays to be tested (as more specifically shown in FIGS. 8-A-8D). Direct airflow speed measurements were performed using a MulticompPro anemometer with a rotating vane (FIGS. 4B, 4C). The anemometer has a 0.4-30 m/s measurable wind speed range and −10° C. to +50° C. allowable temperatures. A plastic adaptor was used to better capture the airflow from the toroid exit and also to protect the anemometer from malfunctioning or getting destroyed in very intense electric fields. The adaptor has an exit diameter of 15 cm.

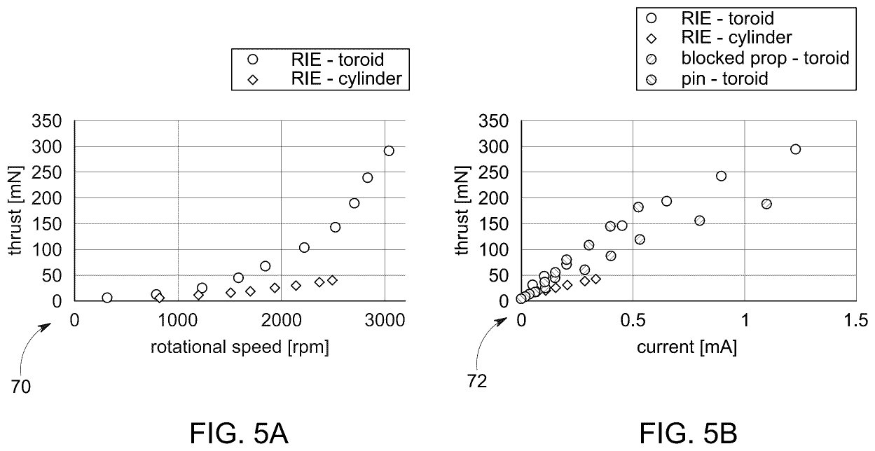

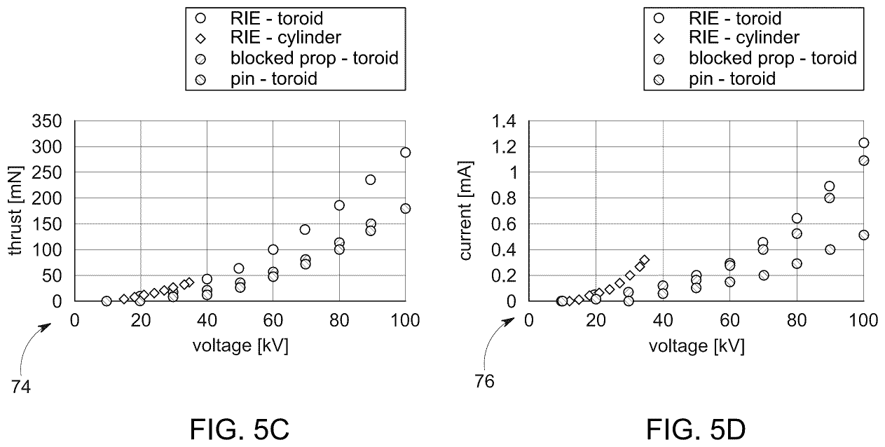

FIG. 5A is a graph 70 illustrating the variation of the ionic axial thrust with rotational speed in RIEs with toroidal counter electrode 28 and cylindrical counter electrode 14. FIG. 5B is a graph 72 illustrating the variation of the ionic axial thrust with current in RIEs with toroidal and cylindrical counter electrodes, with additional comparison made for systems with a blocked ionic propeller and for systems using the shaft/pin as emitter. FIG. 5C is a graph 74 illustrating the variation of the ionic axial thrust with a change in voltage. FIG. 5D is a graph 76 illustrating a current-voltage characteristic of the studied configurations in FIGS. 5B-5C.

The thrust increases with rotational speed of the propeller 26 (FIG. 5A), current (FIG. 5B), and voltage (FIG. 5C). A comparison of the ionic thrust obtained with toroidal RIE 10 versus cylindrical RIE (FIGS. 1A-1B) designed with the same propeller 26 and pin emitters 36 as the toroidal RIE and the same inner diameter (17 cm) of the cylinder counter electrode 4 is shown in FIG. 5A. While the thrust increases approximately linearly with rotational speed for the cylindrical RIE, it increases significantly more than linearly for the toroidal RIE 10.

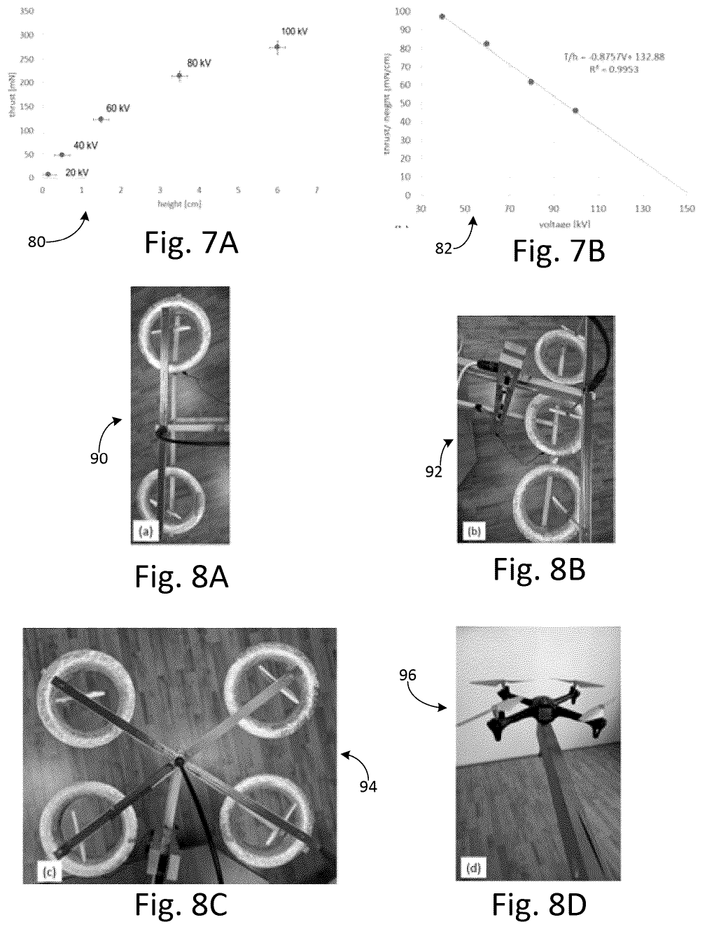

FIG. 7A is a graph 80 illustrating the maximum RIE axial thrust dependance on the propeller 26 axial height above the toroidal counter electrode 28 at various voltages. Error bars are 3 mm height positioning error and 5% estimated measurement thrust error. FIG. 7B is a graph 82 illustrating the variation of the axial thrust per cm height for a 20 kV increase in the applied voltage and positioning of the propeller 26 above toroid counter electrode 28 at the optimal height (maximum thrust for the applied voltage).

A series of measurements were performed at different voltages (increments of 20 kV) and optimum height for each voltage. The results presented in FIG. 7A show an increase in the axial thrust with voltage and optimum height. As the voltage is increased, a greater height is needed to reach the optimal thrust. However, the rate at which the thrust per optimal height increases with the increase in voltage (FIG. 7B) is diminishing. A linear decrease in this rate is suggested by the chart and pointing to a voltage at about 150 kV where any additional gain in the axial thrust will no longer be present.

Additional testing was performed on toroidal RIEs optimized individually to a maximum thrust of about 250 mN at 100 kV. A series of 10 measurements were performed for a single unit RIE to assess the bulk speed of the airflow within the region of the toroid exit area. An anemometer with a rotating vane and the setup shown in FIG. 4B-4C was used to measure the speed of the exit airflow at −100 kV, 1.1 mA and 3057 rpm propeller speed. The measured average speed was 3.96 m/s with a standard deviation of 0.098 m/s (2.47%) at the exit of the air flow adaptor (of 7.5 cm radius). The flow rate corresponds to 251±6.22 m3/h. As the narrowest radius of the toroid is 8.5 cm and assuming the same volume flow rate as for the exit of the airflow adapter, an airflow speed of 3.083±0.387 m/s would result at the toroid exit. The ionic thrust was also measured for each of the 10 anemometer 58 measurements using the seesaw device and the precision electronic scale 62 (FIG. 4D). The average of the 10 measurements provided a scale reading of 264.25 mN with a standard deviation of 2.04 mN (0.76%). The axial ionic thrust (T) can also be calculated from the fundamental force relation:

$$T = \frac{d ( mv )}{dt} = \frac{d ( ρV v )}{dt} = ρ {Av}^{2}$$

$$And$$

$$v = \sqrt{\frac{T}{ρπ {r}^{2}}}$$

where m is the mass of the airflow through a transversal cross-section A, ρ is the air density at room temperature, v is the speed of the airflow in the cross-section A, r is the radius of the circular area A. Using the average value of the measured thrust (0.26425 N), the exit toroid radius (8.5 cm) and 1.2 kg/m3 for the air density at room temperature, the estimated bulk speed of the airflow gives 3.11 m/s—according to relation. The corresponding flow rate through the toroid exit cross-section is 253.99 m³/h or 1.19% larger than the value resulting from anenometer measurements. The value airflow speed is also within 1% difference from the estimated speed for the same toroid cross-section resulting from the anenometer measurements (3.083 m/s). If the cross-section area A is taken at the propeller level (r=6.3 cm), a bulk airflow speed of 4.2±0.032 m/s results.

Toroidal RIE systems with one to 4 RIEs 10 units were tested for potential interference in their performance when working in an assembly of units. They were mounted on a support structure and the joint axial thrust was measured with the same procedure used for a single unit. RIE arrays with 2 to 4 units were mounted on the measuring system as shown in FIGS. 8A-8D.

FIG. 8A is a top view of a two-RIE toroidal array 90 mounted for ionic thrust measurement. FIG. 8B is a top view of a three-RIE toroidal array 92 mounted for ionic thrust measurement. FIG. 8C is a top view of a four-RIE toroidal array 94 mounted for ionic thrust measurement. FIG. 8D is a perspective view of and extant four-blade X15A Guangdong Syma drone 96 mounted for thrust measurement and comparison to the arrays of FIGS. 8A-8D.

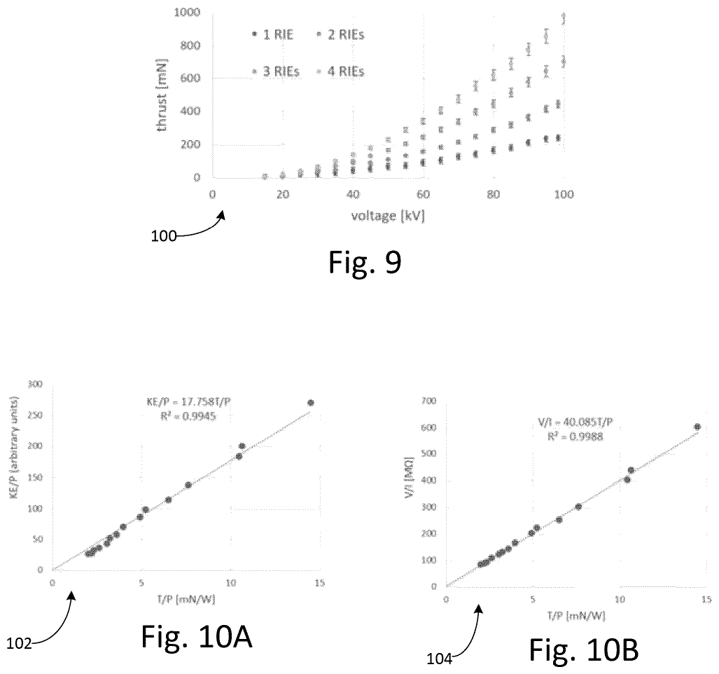

The thrust dependence on voltage and the number of units used is presented in FIG. 9. Small variations of thrust were noticed with the number of toroidal RIEs which can be attributed to the fact that the RIEs were not perfectly identical. Although a dependence on the arrangements of the array may be estimated at large air flow speeds it is not as significant at relatively low airflow speed around 3.11 m/s estimated in our systems in the exit area. The axial thrust of the multi RIE system appears to overall scale linearly with the number of RIE units used as shown in FIG. 9.

FIG. 9 is a graph 100 illustrating toroidal axial thrust dependence on the voltage and the number of parallel-connected units/toroidal RIEs used. The toroidal axial thrust dependence on the voltage and the number of parallel-connected units/toroidal RIEs used. The error bars represent potential measurement errors related to setting the voltage (up to 0.2 kV) and 5% thrust errors (due to the mounting of the RIE on the measuring device and electronic scale readings). Any differences observed in the measurements may be attributed to inherent slight variations in the RIE designs and test conditions.

The thrust of the 4-RIE array 94, FIG. 8C (also FIG. 4D) was compared to a four-blade X15A Guangdong Syma drone 96 (FIG. 8D) which uses similar propeller blade diameter as the RIE array 94. The drone was mounted on the same seesaw device 56 (FIG. 4D) used for testing RIEs. A maximum of 3300 rpm was measured for the blade speed and a 100 g-force (981 mN) for the overall thrust. The thrust X15A drone provided was essentially the same as the maximum thrust recorded for the 4-RIE array (FIG. 9).

FIG. 10A is a graph 102 illustrating the experimentally observed direct proportionality of the thrust to power ratio (T/P) and the propeller kinetic energy to power ratio (KE/P). FIG. 10B is a graph 104 illustrating the experimentally observed direct proportionality of the T/P ratio and the voltage to current (V/I) ratio. A direct proportionality of the thrust to power ratio (T/P) and the propeller kinetic energy to power ratio (KE/P) at voltages much larger than corona onset voltage was observed for toroidal RIEs. The scaled kinetic energy to power ratio (KE/P) for the experimental data is plotted in FIG. 10A against the thrust to power ratio. A linear regression line crossing the origin of axes has a coefficient of determination of 0.9944 which demonstrates the two plotted ratios are in a very close direct proportionality relationship as given by relation.

Thus, the cylindrical RIE (FIGS. 1A-1B) provides the smallest thrust at any given current value. If the propeller is locked and cannot spin in a toroidal RIE, the resultant axial thrust is significantly smaller than for the case the propeller is free to spin but above the values recorded for cylindrical RIE. If the propeller is removed from the toroidal RIE, a pin (emitter)—toroid (counter electrode) system is formed, which at a given current provides marginally more thrust than for the system with the propeller spinning. However, the current does not reach the levels of the toroidal RIE. The maximum thrust for toroidal RIE (288.55) is 63.8% larger than for pin/shaft—toroid configuration (176.1 mN). Both the pin-toroid and the locked propeller-toroid systems provide about the same maximum thrust (181.4 mN and 176.1 mN correspondingly). However, the locked propeller system runs at a current and power (1.23 mA, 123 W) much larger than the pin-toroid system (0.52 mA, 52 W).

A different view of the examined atmospheric ionic thrusters relative performance is given in FIG. 5C. At a given voltage, the largest thrust is given by the cylindrical RIE. Nevertheless, the voltage that can be applied before breakdown is limited by the small distance between the inner surface of the cylinder counter electrode 14 and the pin emitters 36 on the blades 27 placed coaxially and inside the cylinder. This limitation renders the cylindrical RIE to overall generate very small thrust by comparison to the toroidal RIE where voltage breakdown can always be avoided by elevating the propeller more above the counter electrode (which eventually brings the electrical field below the breakdown value). For the present comparison, the maximum value for the toroidal RIE is 778.1% larger than the thrust given by the cylindrical RIE. The thrust provided by the locked propeller and the pin/shaft-toroid systems are very close at any given voltage (with the locked propeller thrust marginally larger) and significantly smaller than for the toroidal RIE (37% smaller at 100 kV and increasingly smaller at lower voltages—by 63.5% at 20 kV). The increase in the thrust of the toroidal RIE with propeller spinning versus the pin/shaft-toroid system at a given voltage is 63.8% larger at 100 kV and increasing up to 429.1% at 20 kV. The thrust generated by the locked propeller versus the pin/shaft-toroid system is marginally larger at any voltage. It demonstrates that the additional pin emitters 36 on the blades 27 do not contribute much to additional axial thrust when the propeller cannot spin. The addition is only 3.2% at 100 kV and increases at lower voltages. At 20 kV the contribution to the original axial thrust provided by the pin-toroid system only is 93%. However, if the propeller is allowed to spin, the contribution amounts to an additional 429.1% at 20 kV.

Although the thrust of the toroidal RIE 10 and the locked propeller system (FIG. 5C) are significantly different (the toroidal RIE was 57.8% larger at 100 kV and with an increasing percentage relative to the locked propeller system at lower voltages), the corresponding currents at a given voltage present much smaller change (11.8% larger at 100 kV)—see FIG. 5D. Once the propeller is allowed to spin freely, the thrust jumps up as the ion momentum in the plane of the propeller rotation is captured and converted into rotational motion and eventually into additional conventional axial thrust. A comparison of the current-voltage characteristics of the systems studied is given in FIG. 5D. At a given voltage, the cylindrical RIE gives the largest current and thrust. At 25 kV it provides about 25% more thrust than the toroidal RIE. However, the difference is reduced with the increase in voltage. Moreover, the breakdown voltage is reached quickly, which caps the corona current and the obtainable thrust in the cylindrical RIE.

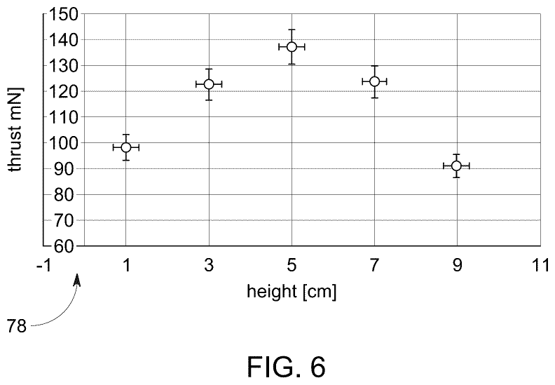

The propeller holding the pin emitters can be placed coaxially at different heights above the toroidal ground (FIG. 3C). In an RIE with toroidal counter electrode 28, the axial thrust is the summation of conventional propeller thrust and the thrust resulting from the axially accelerated ions. The two component values and ratio change with the height of the propeller above. The higher the propeller is positioned above the toroid, the smaller the electric field component E_{y} (FIG. 2A) to accelerate ions in plane of the propeller, the less torque and conventional thrust for a given voltage. The axial thrust (F_{z}+F_{sz}), decreases as well but at a slower rate. Due to the differences in the rates of change in the two axial thrust components, an optimum height with a maximum thrust is expected be present at any given voltage above corona onset. Experimental results show the actual presence of a maximum axial thrust when the voltage is kept constant but the propeller height above the toroid is varied. Such an example is shown in FIG. 6 for a test at ˜98 kV for one of our toroidal RIE units.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A rotational ionic engine, comprising:
at least one rotary device comprising a hub portion, an axis of rotation, and at least one blade extending radially from the hub portion to an outer tip thereof, the at least one blade comprising a front leading edge, a back trailing edge and top and bottom surfaces that extend between the front and back edge;
at least one electrically conductive rotary electrode emitter coupled to the back edge of the at least one blade and proximate to the outer tip of the at least one blade;
at least one electrically conductive counter electrode positioned proximately to the at least one rotary device in a spaced relationship therefrom, the counter electrode having a toroidal body having an internal passage therethrough, the internal passage having an intake and exit for a fluid flow, the internal passage including at least a partial internal taper from the intake to the exit; and
an electrical system comprising a voltage source including a first terminal electrically coupled to the at least one rotary electrode emitter and a second terminal electrically coupled to the at least one counter electrode, the voltage source comprising an electric potential difference between the first terminal and second terminal that selectively generates corona discharges from the at least one rotary electrode emitter to form a flow of ionic wind emanating therefrom that rotates the at least one rotary device about the axis of rotation in a first direction such that the ionic wind flows through the intake of the internal passage of the counter electrode and out from the exit thereof, thereby creating a thrust.

2. The engine of claim 1, wherein the electrical system comprises a battery, a generator, a fuel cell, a solar cell, an electrical grid input line, a supercapacitor, or a combination thereof.

3. The engine of claim 1, wherein the electrical system applies a negative polarity having relatively high-voltage above corona onset to the at least one rotary electrode emitter of the at least one blade.

4. The engine of claim 1, wherein the electrical system applies a positive polarity having a relatively high-voltage above corona onset to the at least one rotary electrode emitter of the at least one blade.

5. The engine of claim 1, wherein the electrical system applies a direct electrical current to the at least one rotary electrode emitter of the at least one blade.

6. The engine of claim 1, wherein the electrical system applies an alternating electrical current to the at least one rotary electrode emitter of the at least one blade.

7. The engine of claim 1, wherein the hub portion comprises an electrically conductive portion that is electrically coupled to the at least one rotary electrode emitter.

8. A ionic propulsion system, comprising:
at least one rotary device configured to convert rotational motion thereof about an axis of rotation in a first direction into thrust, the at least one rotary device comprising a hub portion, an axis of rotation, and at least one blade extending radially from the hub portion to an outer tip thereof, wherein the at least one blade comprises a front leading edge, a back trailing edge and top and bottom surfaces that extend between the front and back edges;
at least one electrically conductive rotary electrode emitter on the at least one blade proximate to the outer tip and back edge thereof;
at least one electrically conductive counter electrode positioned proximate to the at least one rotary device in a spaced relationship, the counter electrode having a toroidal body having an internal passage therethrough, the internal passage having an intake and exit for a fluid flow, the internal passage including at least a partial internal taper from the intake to the exit; and
an electrical system comprising a voltage source including a first terminal that is electrically coupled to the at least one rotary electrode emitter and a second terminal that is electrically coupled to the at least one counter electrode, the voltage source comprising an electric potential difference between the first terminal and second terminal to selectively generate corona discharges from the at least one rotary electrode emitter that form flows of ionic wind that rotate the at least one rotary device about the axis of rotation in the first direction.

9. The system of claim 8, wherein the at least one rotary electrode emitter comprises at least one radially-extending electrically conductive member extending proximate to the back trailing edge and at least one electrically conductive projection that extends away from the back trailing edge of the at least blade in a direction extending from the front leading edge to the back trailing edge, the at least one radially-extending electrically conductive member and the at least one electrically conductive projection being electrically coupled.

10. The system of claim 9, wherein the at least one blade of the at least one rotary device comprises a plurality of blades, and wherein the at least one rotary electrode emitter of each of the plurality of blades comprises the at least one radially-extending electrically conductive member and the at least one electrically conductive projection.

11. The system of claim 8, wherein the front edge, the back edge and the top and bottom surfaces of the at least one blade form an airfoil shape in cross-section.

12. A counter electrode of a rotational ionic engine, comprising:
a toroidal body having an internal passage therethrough, the internal passage having an intake and exit for a fluid flow, the internal passage including at least a partial internal taper from the intake to the exit; and
an electrical connection to an electrical system, the electrical connection selectively providing a voltage to the body,
wherein the toroidal body configured to, upon an electric voltage applied to the electrical connection, receive a flow of ionic wind through the intake of the internal passage of the body and out from the exit thereof, thereby creating a thrust.

13. The electrode of claim 12, wherein the electrical system comprises a battery, a generator, a fuel cell, a solar cell, an electrical grid input line, a supercapacitor, or a combination thereof.

14. The electrode of claim 12, wherein the electrical system applies a negative polarity to the electrical connection.

15. The electrode of claim 12, wherein the electrical system applies a positive polarity to the electrical connection.

16. The electrode of claim 12, wherein the electrical system applies a direct electrical current to the electrical connection.

17. The electrode of claim 12, wherein the electrical system applies an alternating electrical current to the electrical connection.

18. The electrode of claim 12, wherein the body is grounded.

19. The electrode of claim 12, wherein the intake and exit of the body have an internal taper.

20. The electrode of claim 12, wherein the body is configured to be selectively electrically conductive.
